(19) United States
(12) Patent Application Publication
(10) Pub. No.: US 2009/0004633 A1
(43) Pub. Date: Jan. 1, 2009

(54) INTERACTIVE LANGUAGE PRONUNCIATION TEACHING

(75) Inventors: W. Lewis Johnson, Venice, CA (US); Andre Valente, Los Angeles, CA (US); Joram Meron, Zurich (CH)

Correspondence Address: MCDERMOTT WILL & EMERY LLP, 2049 CENTURY PARK EAST, 38th Floor, LOS ANGELES, CA, 90067-3208, US

(73) Assignee: ALELO, INC., LOS ANGELES, CA (US)

(21) Appl. No.: 12/165,258

(22) Filed: Jun. 30, 2008

Related U.S. Application Data
(60) Provisional application No. 60/947,268, filed on Jun. 29, 2007.
(60) Provisional application No. 60/947,274, filed on Jun. 29, 2007.

(51) Int. Cl. G09B 5/00; G09B 19/00

(52) U.S. Cl. 434/169

(57) ABSTRACT

Techniques for language instruction and teaching are described. Methods focus on the sound distinctions that learners have trouble discriminating. Learners practice discriminating these sounds. A learning system is developed using databases of speech from people discriminating these sounds. An embodiment of a method according to the present disclosure can utilize sets of words that differ by only a single syllable containing a sound that is difficult to pronounce, as a way to teach the pronunciation of a word. The sets of similar words can be of a desired number or have a desired number of constituent members. Embodiments of systems can include user interfaces and a automated speech recognition system, including suitable automated speech recognition software, that can interact with a user, e.g., in a pedagogical setting. Related software products including computer-readable instructions resident in a computer-readable medium are described. HMM and DTW algorithms may be used for the embodiments.

### RELATED APPLICATIONS

This application claims priority to U.S. Provisional Patent Application Ser. No. 60/947,268 and U.S. Provisional Patent Application Ser. No. 60/947,274, both filed 29 Jun. 2007; the entire contents of which applications are incorporated herein by reference.

This application is related to the following United States patent applications, the entire contents of all of which are incorporated herein by reference: U.S. patent application Ser. No. 11/421,752, filed Jun. 1, 2006, “Interactive Foreign Language Teaching,” attorney docket no. 28080-206 (79003-014); U.S. Continuation patent application Ser. No. 11/550,716, filed Oct. 18, 2006, “Assessing Progress in Mastering Social Skills in Multiple Categories,” attorney docket no. 28080-208 (79003-015); U.S. Continuation patent application Ser. No. 11/550,757, filed Oct. 18, 2006, “Mapping Attitudes to Movements Based on Cultural Norms,” attorney docket no. 28080-209 (79003-016); U.S. Provisional Application Ser. No. 60/807,569, filed Jul. 17, 2006, entitled “Controlling Gameplay and Level of Difficulty in a Tactical Language Training System,” attorney docket no. 28080-214 (79003-018); and U.S. patent application Ser. No. 11/464,394, filed Aug. 14, 2006, “Interactive Story Development System with Automated Goal Prioritization,” attorney docket no. 28080-217 (79003-019).

### BACKGROUND

Teaching and learning a new language has traditionally been difficult. Often times, someone learning a new language will not easily be able to learn the correct pronunciation of sounds that are not used or commonly used in that person's native language.

Prior art techniques seeking to improve the enunciation of words of a new language have typically consisted of playing audio cues of various words of the new language. Such techniques, while often suitable for eventually teaching someone a new language, have been lacking in effectiveness and time allotted for the teaching process. Such techniques may also not be able to effectively and efficiently teach a new language speaker how to enunciate sounds not present in that speaker's native language and how to differentiate between such new and possibly difficult sounds (phonemes) and similar sounding phonemes.

### SUMMARY

The present disclosure is directed to techniques for language instruction and teaching.

One aspect of the present disclosure is directed to methods by which a computer-based language learning system can help learners learn to improve their pronunciation of the foreign language. The method focuses on the sound distinctions that learners particularly have trouble discriminating. Learners practice discriminating these sounds. The learning system is developed using databases of speech from people discriminating these sounds.

An embodiment of a method according to the present disclosure can utilize sets of words that differ by only a single syllable or phoneme, e.g., a hard to enunciate or difficult syllable or phoneme, as a way to teach the pronunciation of a word. In exemplary embodiments, the words differ by a single phoneme. The sets of similar words can be of a desired number or have a desired number of constituent members, e.g., 4, 5, 6, etc. In exemplary embodiments, two member words can be used. Pronunciation of a member word (or syllable) can be matched to a member word and then graded, giving the user/learner feedback on the learning process.

Embodiments of systems according to the present disclosure can include user interfaces and an automated speech recognition system, including suitable automated speech recognition software, that can interact with a user, e.g., in a pedagogical setting. Embodiments of the present disclosure can include software products, e.g., software code implemented in a computer-readable medium, that are operable to execute methods in accordance with the present disclosure.

Other features and advantages of the present disclosure will be understood upon reading and understanding the detailed description of exemplary embodiments, described herein, in conjunction with reference to the drawings.

### BRIEF DESCRIPTION OF THE DRAWINGS

Aspects of the present disclosure may more fully be understood from the following description when read together with the accompanying drawings, which are to be regarded as illustrative in nature, and not limiting. The drawings are not necessarily to scale, emphasis instead being placed on the principles of the invention. In the drawings:

FIG. 1 depicts a diagrammatic view of a method in accordance with an exemplary embodiment of the present disclosure;

FIG. 2 depicts a diagrammatic view of a method in accordance with an exemplary embodiment of the present disclosure;

FIG. 3 depicts a diagrammatic view representing a system in accordance with an embodiment of the present disclosure; and

FIG. 4 depicts a screen shot of a computer program graphical user interface in accordance with an embodiment of the present disclosure.

While certain embodiments depicted in the drawings and described in relation to the same, one skilled in the art will appreciate that the embodiments depicted are illustrative and that variations of those shown, as well as others described herein, may be envisioned and practiced and be within the scope of the present invention.

### DETAILED DESCRIPTION

The present disclosure is directed to techniques for language learning that utilize focusing on sound distinctions that learners have particular trouble discriminating. Learners practice discriminating these sounds with feedback that includes a grade or score of the leaner's pronunciation of the difficult sounds or words. By carefully selecting and designing prompts that are identical except for the target sounds, and which are relatively easy to pronounce except for the target sounds, the likelihood is maximized that the closeness of fit will be due to the pronunciation of the target sound. Thus, techniques and methods according to the present disclosure can be used to detect errors in the pronunciation of a specific phoneme.

A “native speaker” as used herein is someone who speaks a language as their first language. In the context of the provisional this usually means a native speaker of the target language (the language being taught), e.g., Arabic; the foregoing notwithstanding, the phrase “native speaker of English,’ refers to the case where English is the first language of a particular speaker.

As used herein, the term “baseline results” refers to results generated using the initial version of the speech recognizer that has not been trained using samples of the contrasting word pairs. For example, subsequent to the starting point of the speech recognition training process, as described in further detail below, once more recordings are obtained of learners speaking the contrasting word pairs, the speech recognizer can be retrained and tested on the test set to see whether ability of the automated speech recognition system to discriminate the target sounds improves. When referring to having “models trained with this new data,” it is meant that data is collected from additional speakers.

The techniques of the present disclosure compare a student's (or, equivalently, learner's) input independently against a model, e.g., of “bagha” vs. “bakha,” and then perform a measurement and feedback indication of the closeness of fit of the input utterance to each word or phoneme model.

A key feature is in matching the learner's input utterance against each prompt, where the prompts are constructed in such a way that the match difference is likely to be attributable to the learner's pronunciation of the target sounds, as opposed to extraneous variation in pronunciation of other sounds.

Since an individual phoneme is an internal part of a word, there is no need to look beyond a single word—as the additional input could just confuse an automated speech recognition (“ASR”) program or system (as well as possibly the student). In other words: phoneme pronunciation is a very local phenomenon (in the time domain), with a time scale shorter than a single word. In alternate embodiments, speech matching and discrimination can be applied to larger phrases beyond a single word, but little if any benefit is seen as being available by doing so. Regarding ASR, when a speech recognition algorithm for such analyzes each learner input, it compares the input to a model of how sounds in the language are pronounced, known as an acoustic model. The algorithm tries to find a sequence of sounds in the acoustic model that is the closest fit to what the learner said, and measures how close the fit is. The measure of closeness of fit, however, applies to entire word or phrase, not just the single sound. Attempting to focus the comparison on a single sound turns out not to be very practical, because the speech recognizer cannot always determine precisely where each sound begins and ends. People perceive speech as a series of distinct sounds, however, in reality each sound merges into the next.

An additional aspect of the present disclosure, is that it can often be the case that a particular phoneme, i.e., sound in the language, is pronounced differently depending upon the surrounding sounds. For example, the “t” in “table” is very different from the “t” in “battle”. To properly teach how to pronounce a given sound, it can be useful to practice the sounds in multiple contexts, i.e., construct multiple word pairs using the target sound, each with different surrounding sounds. For example, to teach the difference between “l” and “r” we might use “lake/rake”, “pal/par”, “helo/hero”, etc.

Methods and techniques according to the present disclosure can also be used for detecting and correcting speech errors over longer periods of time, such as prosody. For prosody such techniques can utilize duration and intonation patterns. Each such skill can be taught separately—it's easier to detect, and easier to give understandable feedback.

Suitable speech recognition methods/techniques can be used for embodiments of the present disclosure. Exemplary embodiments may utilize dynamic time warping (“DTW”) and/or hidden Markov modeling (“HMM”), two different speech recognition methods that are described in the literature.

DTW is a dynamic programming technique that can be used to align two signals to each other, which can then be used to calculate a measure of the similarity of the two signals to each other. The name comes from the fact that the two signals (e.g. two recordings of the same word by different speakers) can have different speaking rates at different parts (e.g., heeeelo/heloooo). The DTW method is able to align the corresponding phonemes to each other by warping (or mapping) the time scale of one signal to that of the other so as to maximize the similarity between the (time warped) signals.

As a visual example of dynamic time warping, suppose one signal is the following:

Hhhhhheeeeeeeeeeeeeeeeeeeeeeeellllllooooooooo

and the other is:

hhhhhhhihhhhheeeellllllloolllllooo

The result of the alignment (e.g., warping):

Hhhhhheeeeeeeeeeeeeeeeeeeeeeeellllllooooooooo

Hhhihheeeeeeeeeeeeeeeeeeeeelllloolllloooooooo

The alignment tried to locally stretch and shorten different sub parts of the second utterance to best fit the first one. There can be constraints, however, on the way and degree to which the time warping can be performed (e.g., a part can not be stretched or shortened more than some degree). After the warping, the similarity can be calculated between the two sequences, e.g., by summing the differences between individual aligned frames (letters).

HMM is a method that, by using a large amount of training data, can be used to form statistical models of sub phoneme units and the models themselves can be trained. Typically, phonemes are modeled as 3 to 5 sub phoneme states, which are concatenated one after the other. Once these units are trained in the HMM method, they can be concatenated together and used to generate a similarity score between input speech and the model. For HMM methods, a Hidden Markov Model Toolkit (“HTK”) can be used. The Hidden Markov Model Toolkit (HTK) is a portable toolkit for building and manipulating hidden Markov models. HTK is primarily used for speech recognition research although it has been used for numerous other applications including research into speech synthesis, character recognition and DNA sequencing. HTK is in use at hundreds of sites worldwide. HTK consists of a set of library modules and tools available in C source form. The tools provide sophisticated facilities for speech analysis, HMM training, testing and results analysis. The software supports HMMs using both continuous density mixture Gaussians and discrete distributions and can be used to build complex HMM systems. The HTK release contains extensive documentation and examples.

Suitable DTW speech recognition techniques are described in the following references, the entire contents of all of which are incorporated herein by reference: U.S. Pat. No. 5,073,939 issued 17 Dec. 1991; U.S. Pat. No. 5,528,728 issued 18 Jun. 1996; and U.S. Patent Application Publication No. 2005/0131693 published 16 Jun. 2005. Suitable HMM speech recognition techniques are described in the following references, the entire contents of all of which are incorporated herein by reference: U.S. Pat. No. 7,209,883 issued 24 Apr. 2007; U.S. Pat. No. 5,617,509 issued 1 Apr. 1997; and, U.S. Pat. No. 4,977,598 issued 11 Dec. 1990. Other suitable DTW and/or HMM methods and/or algorithms may be used; further, the speech matching algorithms and methods are not limited to just DTW and HMM ones within the scope of the present disclosure, as other suitable algorithms/techniques (e.g., neural networks, etc.) may be substituted as will be evident to one skilled in the art.

For embodiments based on or including HMM methods/algorithms, training data can be utilized, as the HMM method requires and benefits from training data. Such HMM based embodiments can therefore accommodate the range of variation in how people pronounce sounds, as exemplified by training data. For embodiments based on or including DTW methods/algorithms, training data is not required as the DTW method uses as few as one reference recording, but consequently can only compare an input against that one recording (or number of recordings). Consequently, DTW based embodiments might conceivably give a lower score to utterances that are pronounced perfectly correctly but differ, however, in some trivial way from the reference recording(s). For embodiments utilizing the HMM method, general speech recognition models, can be used to calculate the similarity between the input speech and each of the target words. For embodiments utilizing the DTW method—native speakers of the language in question can be recorded saying each of the target words once, and then the DTW method can be used to calculate the similarity between the student utterance and the two native recordings.

The software compares the inputted sound against specimens of each test word spoke by someone skilled in the language that is being taught. That depends somewhat on the recognition method employed (HMM vs. DTW). The speech is converted into a sequence of feature frames (standard practice—mel scale cepstrum coefficients), e.g., both for HMM and DTW embodiments. In the sound processing, the mel-frequency cepstrum (MFC) is a representation of the short-term power spectrum of a sound, based on a linear cosine transform of a log power spectrum on a nonlinear mel scale of frequency. Mel-frequency cepstral coefficients (MFCCs) are coefficients that collectively make up an MFC. They are derived from a type of cepstral representation of the audio clip (a “spectrum-of-a-spectrum”). The difference between the cepstrum and the mel-frequency cepstrum is that in the MFC, the frequency bands are equally spaced on the mel scale, which approximates the human auditory system's response more closely than the linearly-spaced frequency bands used in the normal cepstrum. This frequency warping can allow for better representation of sound, for example, in audio compression. MFCCs are commonly derived as follows: (i) the Fourier transform is taken of (a windowed excerpt of) a signal; (ii) the powers of the spectrum obtained are mapped onto the mel scale, using triangular overlapping windows; (iii) the logs of the powers at each of the mel frequencies are taken; (iv) the discrete cosine transform is taken of the list of mel log powers, as if it were a signal; and (v) the MFCCs are the amplitudes of the resulting spectrum. There can be variations on this process, for example, differences in the shape or spacing of the windows used to map the scale.

When comparing speech according to the present disclosure, some extracted features of the input speech are compared. As described previously, in HMM embodiments, the input speech can be compared to a sequence of statistical models (e.g., the average and variance of each sub phoneme). In DTW embodiments, the user's speech can be compared to the native speech, e.g., as recorded by native speakers. In HMM embodiments, the speech recognizer can be trained on samples of speech from multiple speakers, so that the system (e.g., its memory or database) can include variations in the way different people speak the same word/sound. Taken further, the DTW could be used with many examples of the word by many speakers (though it is not necessary). Accordingly, acoustic variation, or pronunciation variation (e.g., UK/US pronunciation of “tomato”), can be accommodated.

An iterative approach can be used for developing the speech recognizer. An initial speech recognizer can be developed using a relatively small database of speech recordings. The recognizer can be integrated into a (beta) version of the language teaching system, which records the learner's speech as he or she uses it. Those recordings can subsequently be added to a speech database, with which the speech recognizer can be retrained (i.e., subject to additional training). The resulting recognizer can have higher recognition accuracy, since it will have been trained on a wider range of speech variation.

Embodiments of the present disclosure can be utilized in conjunction with a suitable automated speech recognition (“ASR”) program or system for training learners to produce and discriminate sounds that language learners commonly have difficulty with. This ability to discriminate sounds applies regardless of whether the sounds appear in words or phrases. Techniques according to the present disclosure can utilize prompts (e.g., saxa vs. saHa) that differ only in terms of the target sounds, and where the other sounds in the prompts are relatively easy for learners to pronounce. Because the prompts differ preferably only in terms of the target sounds, any differences that the associated ASR program or system detects in the learner's pronunciation of the prompts is likely to be attributable to the target sounds. Because the other sounds are relatively easy for learners to pronounce, there is not likely to be as much variation in how learners pronounce the other sounds, which might interfere with the ASR algorithm's ability to analyze and discriminate the prompts.

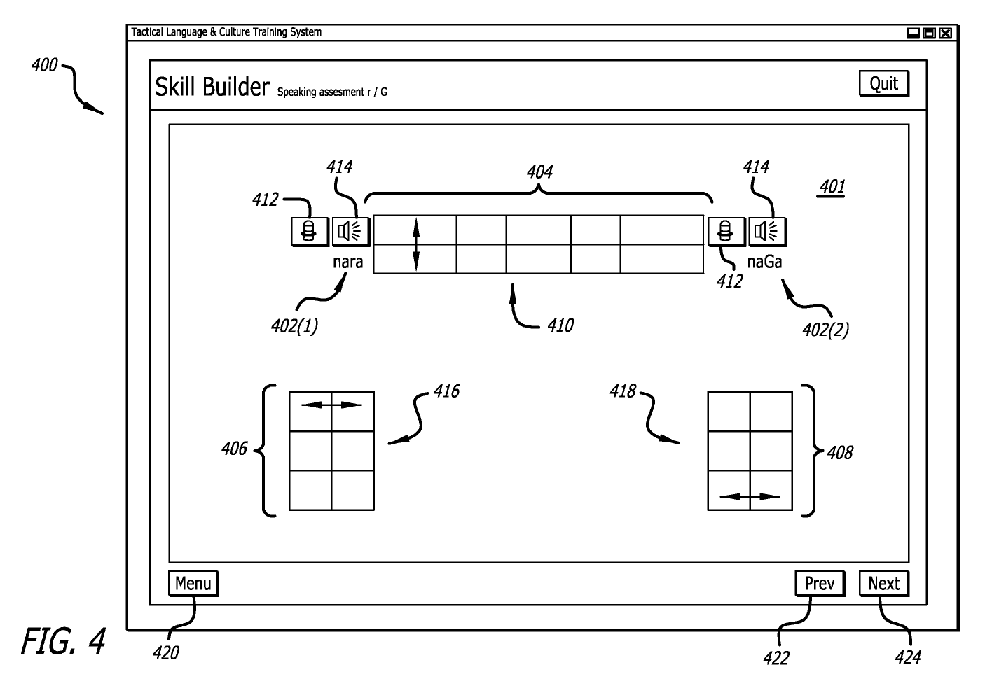

The words or sounds that are used can be indicated on a user interface, such as on a computer display or handheld device screen, as prompts, which can be a combination of visual and audible prompts. The learner (student) can see the prompts in written form, either in the written form of the target language or a Romanized transcription of it. The learner also has the option of playing recordings of the prompts, spoken by native speakers. This can be accomplished, for example, by a user clicking on speaker icons in the figure of a particular screenshot, e.g., screenshot 400 of FIG. 4.

Audible prompts can be utilized to recite the very sounds the learner is supposed to utter or try to learn. In exemplary embodiments, the student/learner can be asked to recite only one sound at a time. As for enunciation of the members of the set (of similar sounds), the learner is free to practice each pair of sounds in any order, e.g., start with “kh”, switch to “gh”, and then go back to “kh”. The groups (e.g., pairs) of contrasting words or phonemes themselves can in principle be covered in any order, however, it may be most effective to define a curriculum sequence, from easy to difficult and from more common to less common.

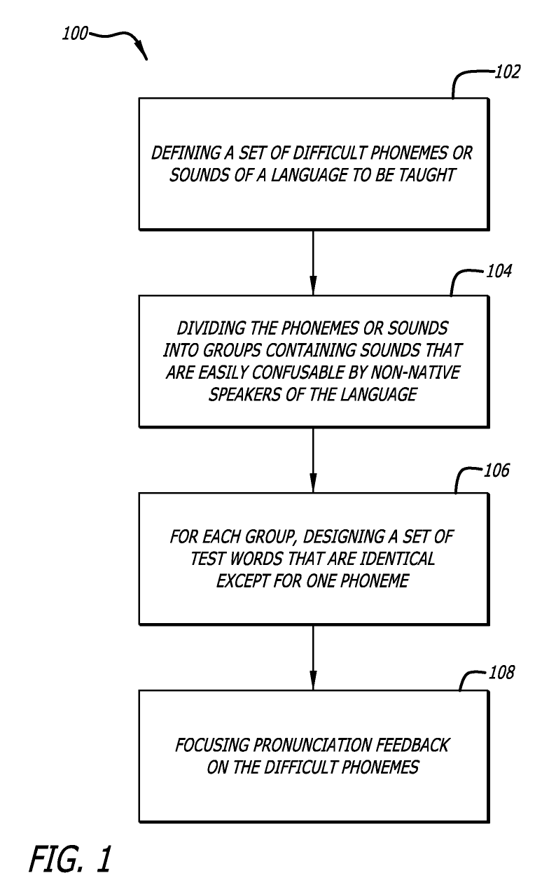

FIG. 1 depicts a diagrammatic view of a method 100 in accordance with an exemplary embodiment of the present disclosure. A set of difficult phonemes or sounds in a language, that is desired to be taught to a user, can be defined as described at 102. The phonemes or sounds can be divided into groups that contain sounds that are easily confusable by non-native speakers of the language, as described at 104. For each group, a set of test words can be designed that are identical except for one phoneme (e.g., the easily confusable or difficult one), as described at 106. The user's utterance of the one identified phone (in the test words) can be used to focus feedback on the difficult phoneme in the learning process, as described at 108.

### Example in Iraqi Arabic

In an exemplary embodiment, in accordance with FIG. 1, a set of difficult Iraqi phonemes (sounds) was defined to focus pronunciation feedback on. The acoustic models utilized are not necessarily expected to be able to robustly detect all of the phonemes, but at least some. The sounds (phonemes) were divided into 5 groups—each group contained sounds that are considered to be easily confusable by native speakers of English, e.g., one group contains x, H and h—x and H are difficult for native English speakers, and are often interchanged, as well as replaced by the h, which exists in English.

For each of these groups, a set of test words were designed: the words for each group were identical, except for one phoneme (e.g., for the x/H/h group, we can use saxa/saHa/saha). The words were designed so that they would be easy for an English native to pronounce (except for the phoneme in question), and would avoid soliciting a large number of pronunciation variations. Recordings of the test words were collected. The recordings can be used to evaluate the recognition accuracy of the acoustic models.

Baseline results were generated for both the HMM method and the DTW method (template based recognition). The detailed baseline results are presented in Tables 1-2, infra.

TABLE 1
HTK BASELINE RESULTS FOR PRONUNCIATION ERROR
DETECTION SUMMARY HMM BASELINE RESULTS
A confusion matrix for groups 1-5 is shown below. Each row corresponds
to actually uttered word. Each column corresponds to recognition results.

| Group 1 | bada | baza | baZa | basa | badha | baSa |
|---|---|---|---|---|---|---|
| bada | 94.44% | 0.00% | 5.56% | 0.00% | 0.00% | 0.00% |
| baza | 0.00% | 78.26% | 8.70% | 8.70% | 0.00% | 4.35% |
| baZa | 19.23% | 0.00% | 80.77% | 0.00% | 0.00% | 0.00% |
| basa | 0.00% | 0.00% | 0.00% | 100.00% | 0.00% | 0.00% |
| badha | 44.44% | 0.00% | 38.89% | 0.00% | 16.67% | 0.00% |
| baSa | 0.00% | 0.00% | 0.00% | 100.00% | 0.00% | 0.00% |

Total: 73.25% correct out of 172

| Group 2 | hata | Hata | xata |
|---|---|---|---|
| hata | 78.95% | 15.79% | 5.26% |
| Hata | 32.26% | 54.84% | 12.90% |
| xata | 12.50% | 16.67% | 70.83% |

Total: 66.22% correct out of 74

| Group 3 | Mata | maTa |
|---|---|---|
| mata | 96.55% | 3.45% |
| maTa | 47.83% | 52.17% |

Total: 76.92% correct out of 52

| Group 4 | nara | naGa | naga | naRa |
|---|---|---|---|---|
| nara | 100.00% | 0.00% | 0.00% | 0.00% |
| naGa | 39.13% | 56.52% | 4.35% | 0.00% |
| naga | 66.67% | 0.00% | 33.33% | 0.00% |
| naRa | 16.67% | 0.00% | 0.00% | 83.33% |

| Total: 78.08% correct out of 73 | | | | |
|---|---|---|---|---|
| Group 5 | saQa | sa9a | saa | saGa |
| saQa | 92.00% | 0.00% | 8.00% | 0.00% |
| sa9a | 73.68% | 10.53% | 15.79% | 0.00% |
| saa | 83.33% | 12.50% | 4.17% | 0.00% |
| saGa | 0.00% | 0.00% | 16.67% | 83.33% |

Total: 41.89% correct out of 74

For the groups (1-5), the correct recognition rates were as follows: Group 1 (basa . . . ) 73.26% correct; Group 2 (hata . . . ) 66.22% correct; Group 3 (mata . . . ) 76.92% correct; Group 4 (nara . . . ) 78.08% correct; and Group 5 (saa . . . ) 41.89% correct; with an overall recognition rate for the total set of words of 68.09% correct.

TABLE 2
DTW BASELINE RESULTS FOR
PRONUNCIATION ERROR DETECTION
A confusion matrix for the groups 1-5 is shown below.
Each row corresponds to an actually uttered word.
Each column corresponds to recognition results.

| Group 1 | bada | baZa | badha | basa | baza | baSa |
|---|---|---|---|---|---|---|
| bada | 92.59% | 3.70% | 3.70% | 0.00% | 0.00% | 0.00% |
| baZa | 38.46% | 38.46% | 3.85% | 0.00% | 19.23% | 0.00% |
| badha | 66.67% | 0.00% | 0.00% | 0.00% | 33.33% | 0.00% |
| basa | 3.03% | 3.03% | 0.00% | 45.45% | 48.48% | 0.00% |
| baza | 8.70% | 0.00% | 0.00% | 17.39% | 73.91% | 0.00% |
| baSa | 5.56% | 0.00% | 0.00% | 50.00% | 44.44% | 0.00% |

Total: 53.49% correct out of 172

| Group 2 | Hata | hata | xata |
|---|---|---|---|
| Hata | 64.52% | 22.58% | 12.90% |
| hata | 47.37% | 52.63% | 0.00% |
| xata | 20.83% | 16.67% | 62.50% |

Total: 60.81% correct out of 74

| Group 3 | maTa | mata |
|---|---|---|
| maTa | 86.96% | 13.04% |
| mata | 10.34% | 89.66% |

Total: 88.46% correct out of 52

| Group 4 | naGa | naRa | nara |
|---|---|---|---|
| naGa | 47.83% | 21.74% | 30.43% |
| naRa | 0.00% | 66.67% | 33.33% |
| nara | 0.00% | 4.35% | 95.65% |
| Total: 70.00% correct out of 70 | | | |
| Group 5 | saQa | saa | sa9a |
| saQa | 20.00% | 60.00% | 20.00% |
| saa | 0.00% | 83.72% | 16.28% |
| sa9a | 5.26% | 42.11% | 52.63% |

Total: 58.62% correct out of 87

Summary of HMM baseline results were the following: Group 1 (basa . . . ) 53.49% correct; Group 2 (hata . . . ) 60.81% correct; Group 3 (mata . . . ) 88.46% correct; Group 4 (nara . . . ) 70.00% correct; Group 5 (saa . . . ) 58.62% correct; with a total of Total: 66.5% correct.

The baseline results were obtained over a test database collected internally. The database included 5 groups of words with confusable sounds (16 words in total). One native speaker and 8 non-native speakers were recorded, repeating each word at least 3 times (444 non-native utterances in total). After the recordings were done, we listened to each recording, and annotated it according to what was actually said (this is not always easy, as some of the produced sounds are in the gray area between two native sounds)> In addition, the speakers sometimes said words not in the initial list, so we added a few words to the recognition tests of the HMM method (but not the DTW method).

For the baseline results, the correct recognition rate was calculated for each word group separately and for the total set of words. In addition, a confusion matrix was calculated, i.e., for each word actually said, the percentage of times it was recognized as any of the possible words.

For an embodiment utilizing the DTW method, a comparison was made of each non-native utterance to all of the native utterances of words in the corresponding word group (3 recordings per word), and selected the native recording with the best match score as the recognition result.

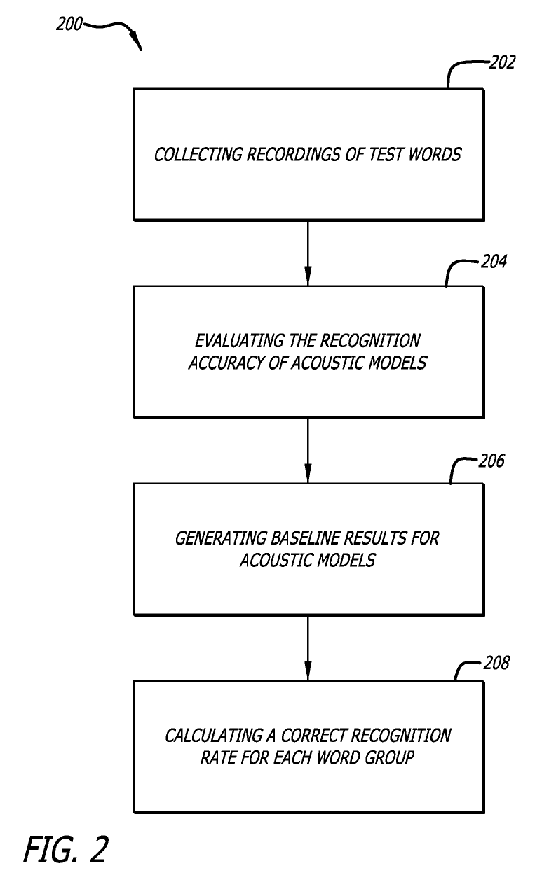

FIG. 2 depicts a diagrammatic view of a method 200 in accordance with an exemplary embodiment of the present disclosure. Recordings of test words, e.g., as defined at 106 in FIG. 1, can be collected, as described at 202. The recognition accuracy of acoustic models can be evaluated, as described at 204. Baseline results for the acoustic models can be generated, as described at 206. A correct recognition rate can be calculated for each word group as described at 208.

Baseline tests, e.g., as shown and described for Tables 1-2 and FIG. 2, described infra, can be used to uncover the limitations of the acoustic models employed. For both DTW and HMM embodiments, the present inventors have found that while some phonemes are detected with high reliability, others can be more difficult to detect correctly. Experimentation may be advantageous to try to improve the detection of the poorly recognized phonemes. For example, for embodiments utilizing DTW speech recognition methods, replacing the native recordings used as recognition templates may be beneficial—as some unwanted vowel variation (in addition to intended phoneme variation) was observed, which might account for some recognition bias. For embodiments utilizing HMM method, poor recognition results are believed to correlate to phonemes for which there were only a small number of examples in the training database (e.g., the phoneme ‘S’—pharyngealized ‘s’—has no instance in the non-native training data, and the phoneme ‘Q’—glottal stop—is one which can be freely omitted, and therefore often mislabeled). For such poorly recognized phonemes, it may be desirable to have a native go over all occurrences in the database, and then test for performance change of the models trained with this new data. If no improvement is observed, it may be appropriate to conclude this phoneme is particularly difficult to detect. In addition, an analysis may be performed of non-native data collected, to obtain statistics for actual phoneme confusion by non natives. This may provide a baseline as to where the most common problems lie, and how a strategy can be formulated for dealing with different types of problems.

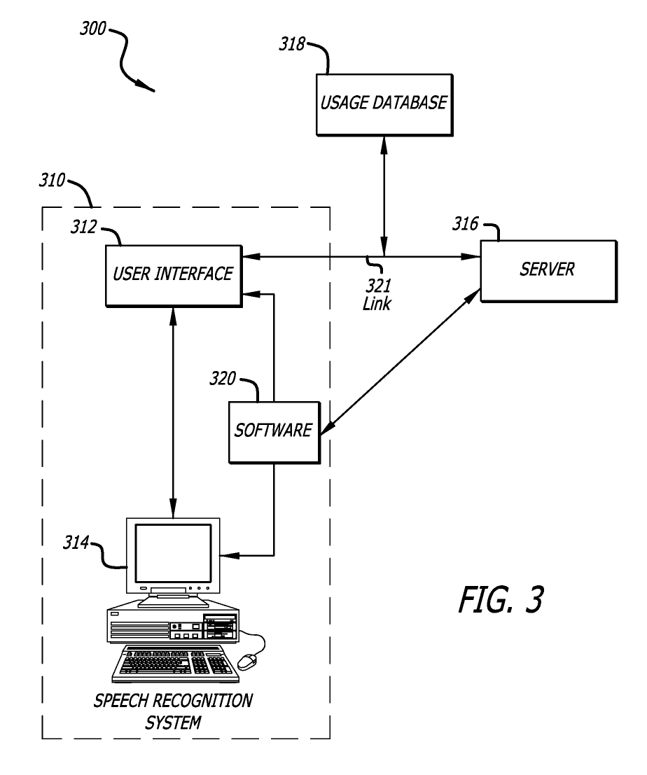

FIG. 3 depicts a diagrammatic view representing a system in accordance with an embodiment of the present disclosure. System 300 can include a user-accessible component or subsystem 310 having a user interface 312 and a speech recognition system 314. System 300 can include a remote server and/or a usage database 318 as shown. Software 320 including speech recognition and/or acoustic models can also be included; such software can include different components, which themselves may be located or implemented at different locations and may be run or operate over one or more suitable communications links 321, e.g., a link to the World Wide Web, as shown. The user interface 312 of system 300 can include one or more web-based learning portals. User interface 312 can include a screen display (which can be interactive, such as a touch screen), a mouse, a microphone, a speaker, etc.

System 300 can also include Web-based authoring and production tools, as well as run-time platforms and web-based interactions for desktop and/or laptop (portable) computers/devices and handheld devices, e.g., Windows Mobile computers and the Apple iPod. System 300 can also implement or interface with PC-based games, such as the “Mission to Iraq” interactive 3D video game available from Alelo Inc., the assignee of the present disclosure. In exemplary embodiments, system 300 can include the Alelo Architecture™ available from Alelo Inc.

The user interface 312 can include a display configured and arranged to display visual cues offering feedback of a user's (a/k/a a “learner's”) enunciation of difficult phonemes, e.g., as identified at 102 of the method of FIG. 1. Such visual cues can include a sliding scale and/or color coding, e.g., as shown and described for the screenshot shown in FIG. 4, infra, though such cues are not the only type of feedback that can be used within the scope of the present disclosure. Various forms of reports and other feedback can be provided to the user or learner. For example, the user could receive a letter grade or other visual indication of a score/grade/performance evaluation. The system could identify the part of the spoken language that is flawed and in what ways. Also, the flow of the lesson could be affected by the degree of accuracy in the pronunciation.

FIG. 4 depicts a screen shot 400 of a graphical user interface 401 (e.g., “Skill Builder Speaking Assessment”) operating in conjunction with a computer program product/software according to the present disclosure. Such a computer program can be one that implements or runs one or more of the methods of FIGS. 1-2. One type of report is illustrated in the attached screenshot of FIG. 4. Of course, other report methods may be used.

User interface 401 includes two test words designed to be similar except for one phoneme. In the embodiment shown, the screenshot (and related system and method) is designed to provide a speaking assessment between the phonemes for “r” and “G” in the specific language in questions, e.g., Iraqi Arabic. The test words are indicated at 402(1)-402(2), which for the screen shot shown are “nara” and “naGa,” respectively.

In the screenshot of FIG. 4, a top scale 404 is present to provide an evaluation of the learner's most recent pronunciation attempt. The needle 410 shown indicates that the last pronunciation attempt sounded close to the target sound on the left (“r”, like the “r” in Spanish). If there is no match, e.g., the speech recognition software/component and acoustic models do not indicate a match, the needle 404 on the top scale would move to the red zone in the middle of scale 404. Icons 412 can be present so that a user can select when to input (record) his or her utterance of the test word(s). Icons 414 can be present so that the user can have the test word(s) played for him or her to listen to. Additional user input icons may also be present, e.g., “Menu” 420, “Prev” 422, and “Next” 424, as shown.

With continued reference to FIG. 4, meters or scales 406 and 408 can be present at bottom of page to indicate overall performance. For example, scale 406 at the bottom left can be present to show the learner's performance in performing “r”, over multiple trials. For the example shown, needle 416 is in the green area, indicating that the learner's cumulative performance is good. A scale 408 at the bottom right includes a needle 418 that shows the learner's cumulative performance in pronouncing “G” (our symbol for an R in the back of the mouth, as in French). The cumulative performance for the user's pronunciation of this particular phoneme is indicated as being poor in the example shown.

Accordingly, by carefully designing and setting up the linguistic task for the language teaching, embodiments of the present disclosure can more effectively facilitate correct pronunciation than prior art techniques. Moreover, using a speech processing method that returns an acoustic similarity score between two utterances (which score can be based on or derived from suitable statistical methods, neural networks, etc.) can also facilitate increased learning of correct pronunciation of a new language. As described previously, HMM and/or DTW methods can be utilized in exemplary embodiments to pronunciation feedback to a learner.

While certain embodiments have been described herein, it will be understood by one skilled in the art that the methods, systems, and apparatus of the present disclosure may be embodied in other specific forms without departing from the spirit thereof. For example, while the user input (e.g., to the methods of FIGS. 1-2 and system 300 of FIG. 3) has been described in the context of the sound of the person's/user's voice, other signals, such as mouse clicks, can be used to start and stop the speech recognizer. In exemplary embodiments, methods can utilize mouse clicks to signal when sound processing should start and stop. In alternative embodiments, there are alternative valid methods that do not involve mouse clicks, e.g., the speech recognizer starts automatically when a sound input is detected. Other devices could be used such as a push-to-talk microphone, although in general the exemplary embodiment is one where the user clicks or presses a button to indicate that he or she is about to start speaking, since it reduces the possibility that the ASR might be triggered by some extraneous sound.

Accordingly, the embodiments described herein are to be considered in all respects as illustrative of the present disclosure and not restrictive.

What is claimed is:

1. A language learning system comprising:
a user interface that is configured and arranged to prompt a learner to speak an utterance of one or more defined difficult phonemes to generate feedback regarding errors in the learner's spoken language production of a language to be learned; and
a speech recognition system configured and arranged to receive the learner's spoken language utterance and to provide feedback of a degree of closeness of the utterance to the one or more defined difficult phonemes.

2. The language learning system of claim 1, wherein the errors are instances of a plurality of error types.

3. The language learning system of claim 1, wherein the phonemes comprise words or phrases in a language foreign to the learner.

4. The language learning system of claim 1, wherein system comprises interactive exercises that focus on sets of the one or more difficult phonemes.

5. The language learning system of claim 2, wherein the error types reflect limitations in the learner's spoken language proficiency.

6. The language learning system of claim 5, wherein the error types include errors in language pragmatics, semantics, syntax, morphology, and phonology.

7. The language learning system of claim 5, wherein the error types include errors in language phonology.

8. The language learning system of claim 7, wherein the errors are mispronunciations of phonemes that language learners commonly confuse.

9. The language learning system of claim 1, wherein the speech recognition system comprises a speech recognition algorithm configured and arranged to provide an indication of a degree of closeness of the user's utterance to a phoneme or word in the language.

10. The language learning system of claim 9, wherein the speech recognition algorithm is DTW or a HMM algorithm.

11. A method of language teaching, the method comprising:
defining a set of difficult phonemes of a language to be taught;
dividing the phonemes into groups containing sounds that are easily confusable by non-native speaker of the language;
for each group, designing a set of test words that are identical except for one phoneme; and
prompting a learner to pronounce the difficult phonemes.

12. The method of claim 11, wherein designing a set of test words comprises collecting recordings of test words.

13. The method of claim 11, wherein designing a set of test words comprises evaluating the recognition accuracy of acoustic models.

14. The method of claim 11, wherein designing a set of test words comprises generating baseline results for acoustic models.

15. The method of claim 11, wherein designing a set of test words comprises generating a correct recognition rate for each word group.

16. The method of claim 11, wherein defining a difficult set of phonemes includes taking a survey of a group of non-native speakers of the language.

17. The method of claim 11, further comprising implementing a speech recognition system comprising a DTW or a HMM algorithm configured and arranged to provide an indication of a degree of closeness of the user's utterance to a phoneme or word in the language.

18. The method of claim 17, wherein the algorithm comprises a HMM method algorithm and further comprises accumulating amounts of training data to score any input utterance.

19. The method of claim 17, wherein the algorithm comprises a DTW method algorithm and uses one or more recordings.

20. A software product including a computer-readable medium with resident computer readable instructions comprising:
defining a set of difficult phonemes of a language to be taught;
dividing the phonemes into groups containing sounds that are easily confusable by non-native speaker of the language;
for each group, designing a set of test words that are identical except for one phoneme; and
prompting a user to pronounce the difficult phonemes.

21. The software product of claim 20, wherein the instructions for designing a set of test words comprise instructions for collecting recordings of test words.

22. The software product of claim 20, wherein the instructions for designing a set of test words comprise instructions for evaluating the recognition accuracy of acoustic models.

23. The software product of claim 20, wherein the instructions for designing a set of test words comprise instructions for generating baseline results for acoustic models.

24. The software product of claim 20, wherein the instructions for designing a set of test words comprise instructions for generating a correct recognition rate for each word group.

25. The software product of claim 20, wherein the instructions for defining a difficult set of phonemes includes instructions for taking a survey of a group of non-native speakers of the language.

26. The software product of claim 20, further comprising instructions for implementing a speech recognition system comprising a DTW or a HMM algorithm configured and arranged to provide an indication of a degree of closeness of the user's utterance to one or more reference model or recording of the phoneme or word as used by a speech recognition algorithm.

27. The software product of claim 26, wherein the instructions for implementing the algorithm include instructions for implementing a HMM method algorithm and further comprise instructions for accumulating amounts of training data to score any input utterance.

28. The software product of claim 26, wherein the instructions for implementing the algorithm include instructions for implementing a DTW method algorithm and further comprise instructions for uses one recording.

29. An interactive language pronunciation teaching system comprising:
a user interface that is configured and arranged to prompt a learner to speak an utterance of one of two or more defined words that each include an easy syllable and a difficult syllable for non-native speakers, and wherein the two or more words are similar except for the difficult syllable; and
a speech recognition system configured and arranged to receive the learner's spoken language utterance and, as feedback, to provide an indication of a match or lack of a match of the utterance to one of the two or more defined words.

30. The system of claim 29, wherein the speech recognition system is configured and arranged to provide to the learner a degree of a match to one of the two or more words.

31. The system of claim 29, wherein the user interface is configured and arranged to prompt the learner by playing a recording of one of the two or more defined words.

32. The system of claim 31, wherein the user interface is configured and arranged to allow the learner to select which word prompt is played by the system.

33. The system of claim 29, wherein the speech recognition system comprises software comprising a speech recognition algorithm.
